(19) United States
(12) Patent Application Publication
(10) Pub. No.: US 2002/0127173 A1
(43) Pub. Date: Sep. 12, 2002

(54) Process for utilizing waste salt mixtures from halex reactions

(76) Inventors: Andreas Bulan, Langenfeld (DE); Joachim Herzig, Leichlingen (DE)

Correspondence Address: BAYER CORPORATION, PATENT DEPARTMENT, 100 BAYER ROAD, PITTSBURGH, PA, 15205, US

(21) Appl. No.: 10/043,979

(22) Filed: Jan. 10, 2002

(30) Foreign Application Priority Data
Jan. 15, 2001 (DE) 10101394.9

(51) Int. Cl. C01B 7/01; C01B 7/19; C04B 11/00

(52) U.S. Cl. 423/484; 423/482; 106/772

(57) ABSTRACT

The invention relates to a process for utilizing waste salt mixtures from HALEX reactions, comprising at least one alkali metal chloride and at least one alkali metal fluoride or bifluoride, and optionally one or more organic compounds, which are depleted by extraction, by contacting the resulting waste salt mixture with concentrated sulfuric acid, removing the resulting hydrogen chloride for the most part by flushing with an inert gas, and reacting the salt-containing sulfuric acid with calcium fluoride to give hydrogen fluoride and alkali metal sulfate-containing calcium sulfate, which can be processed to give a building material binder.

### BACKGROUND OF THE INVENTION

The invention relates to a process for working up and utilizing waste salt mixtures, such as are produced, for example, when halogen exchange reactions, so-called HALEX reactions (where HALEX is short for “halogen exchange”), are carried out.

In such reactions, chlorine atoms, for example, are exchanged for fluorine atoms in organic compounds. In the process, alkali metal fluorides or bifluorides are used, which are reacted in the course of the reaction to give the corresponding alkali metal chlorides (cf. Houben-Weyl, “Methoden der organischen Chemie” [Methods of organic chemistry], 4th Edition, Volume V, Part 3, 1962, page 145 ff; Ullmann's Encyclopedia of Industrial Chemistry, 5^{th}, 1988, Vol. A11, page 379).

In simple terms, such reactions can be represented as follows:

R−Cl+MF→R−F+MCI

Here, R is an organic radical and M is an alkali metal.

Since HALEX reactions are generally carried out with excess alkali metal fluoride and the reaction product is separated off in most cases by distillation, waste salt mixtures are produced that comprise, in addition to residues of organic compounds, alkali metal chlorides and alkali metal fluorides or bifluorides. These waste salt mixtures have hitherto mainly been disposed of in landfills or, following removal of adhering organics, subjected to a complex recycling process (DE-A 199 17 610).

It was therefore the object to find a way of reusing such waste salt mixtures.

### DETAILED DESCRIPTION OF THE INVENTION

Alkali metal are understood as meaning, for example, lithium, sodium, cesium, and, particularly, potassium. In this context, organic compounds mean, for example, starting materials and by-products of the HALEX reaction, such as p-chloronitrobenzene or tetrachlorobenzo-trifluoride.

The waste salt mixtures produced directly from HALEX reactions may usually comprise 30 to 60% by weight of alkali metal chlorides, 10 to 50% by weight of alkali metal fluorides or bifluorides, and 0 to 30% by weight of organic compounds. These mixtures are first extracted with a suitable solvent in which the alkali metal halides are insoluble (e.g. acetone and dichloromethane).

The waste salt mixtures depleted of organics in this way may comprise 0 to 5% by weight (preferably 0 to 1% by weight) of organic carbon and are contacted, per mole of alkali metal, for example, with 2 mol to 120 mol (preferably 6 to 60 mol) of concentrated sulfuric acid for which the content is generally ≧94% by weight (preferably ≧98% by weight).

The pressure during the contacting can be, for example, 0.4 to 2.0 bar, preferably 0.5 to 1.2 bar. Temperatures that may be chosen for this contacting are, for example, 0° C. to 300° C., preferably 20° C. to 250° C.

The hydrogen chloride that is formed is removed by flushing (stripping) with an inert gas, preferably with air, nitrogen, or a mixture of the two, which is then passed to a scrubber. The flushing period can, for example, be between 10 minutes and 24 hours, and the pressure within the stripping column can be 0.4 to 2 bar, preferably 0.8 to 1.2 bar.

The salt-containing sulfuric acid obtained in this way generally has a chloride content of <300 mg/kg. If such acid, optionally following the addition of further concentrated sulfuric acid until the molar ratio of alkali metal to sulfuric acid is 1:40 to 1:1300 (preferably 1:80 to 1:200), is reacted with calcium fluoride, a low-chloride hydrogen fluoride is formed that is sufficiently pure for industrial application. Furthermore, a low-water calcium sulfate comprising between 0.07 and 2.5 mol % (preferably between 0.4 and 1.2 mol %) of alkali metal sulfate, which can, for example, following neutralization of any acid still present (for example, using calcium oxide) be processed to give a calcium sulfate binder.

Low-water calcium sulfate (anhydrite) is used in the construction industry, optionally admixed with additives such as water or sand, e.g., as binder. For adequate setting rate and strengths, an activator, such as, for example, potassium sulfate, normally has to be added (DAS 1062609, 1956).

As a result of the process according to the invention, activator is already present and homogeneously distributed in the calcium sulfate binder, which renders unnecessary the processing expenditure of subsequently mixing in the activator. Where the alkali metal is potassium, the amount of potassium sulfate in the calcium sulfate binder prepared according to the invention is, for example, between 0.1 and 3% by weight, preferably 0.5 to 1.5% by weight.

The following example further illustrates details for the process of this invention. The invention, which is set forth in the foregoing disclosure, is not to be limited either in spirit or scope by this example. Those skilled in the art will readily understand that known variations of the conditions of the following procedures can be used. Unless otherwise noted, all temperatures are degrees Celsius and all percentages are percentages by weight.

### EXAMPLE

A waste salt mixture from the preparation of tetrafluorobenzo-trifluoride comprised the following constituents (% by weight): 21.3% of organic compounds, 34.2% of potassium fluoride, and 44.5% of potassium chloride.

This waste mixture was subjected to extraction with acetone, after which the carbon content of the resulting waste salt mixture was <0.7% by weight and the proportion of organic hydrogen was <1.0% by weight.

2.25 t of this waste salt mixture were admixed at 30° C. with 219 t of concentrated sulfuric acid (98.5% by weight). The resulting reaction mixture was flushed (stripped) with nitrogen in a scrubbing tower over a period of 8 hours at a pressure of 1 bar. The chloride content of the salt-containing sulfuric acid after this procedure was less than 300 mg/kg.

172 t of calcium fluoride were then added. As well as hydrogen fluoride (water content 0.03%, sulfur dioxide content 0.002%), 300 t of low-water calcium sulfate with a proportion of 1% by weight of calcium sulfate were obtained, which, following neutralization of residual acid with calcium oxide, was ground to give a calcium sulfate binder. This binder satisfied the requirements when tested in accordance with DIN 4208. The binder prepared according to the invention was compared with a calcium sulfate binder to which the activator potassium sulfate (also 1% by weight) was only added afterwards. The result is shown in the table below.

| | Calcium sulfate binder in | Calcium sulfate binder |
|---|---|---|
| | accordance with the | 1% by weight of |
| | preparation of the | potassium sulfate |
| | invention (example) | added afterwards |
| Setting time [mm] | | |
| Start | 40 | 35 |
| End | 120 | 110 |
| Compressive strength | | |
| [N/mm²] | | |
| 3 days | 12 | 11 |
| 28 days | 28 | 26 |
| Flexural tensile | | |
| strength [N/mm²] | | |
| 3 days | 3.0 | 3.2 |
| 28 days | 6.0 | 6.0 |

What is claimed is:

1. A process for utilizing waste salt mixtures from HALEX reactions comprising
(1) extracting organic constituents from a waste salt mixture comprising at least one alkali metal chloride and at least one alkali metal fluoride, and optionally at least one organic compound,
(2) contacting the resulting waste salt mixture with an excess amount of concentrated sulfuric acid,
(3) flushing the resulting hydrogen halides from the resulting mixture by passing an inert gas through it, and
(4) reacting the resulting salt-containing sulfuric acid with calcium fluoride to give hydrogen fluoride and an alkali metal sulfate-containing calcium sulfate binder.

2. A process according to claim 1 wherein the alkali metal fluoride originally used for the HALEX reaction is potassium fluoride or potassium bifluoride.

3. A process according to claim 1 wherein the temperature when contacting with sulfuric acid is 0° C. to 300° C.

4. A process according to claim 1 wherein the inert gas used to remove the hydrogen halide is air, nitrogen, or a mixture thereof.

5. A process according to claim 1 wherein
(a) the salt-containing sulfuric acid that is present following the removal of hydrogen halides is reacted with calcium fluoride,
(b) excess acids are neutralized with calcium oxide, and
(c) the resulting calcium sulfate is ground to give a calcium sulfate binder.

6. A building material binder comprising calcium sulfate binder prepared according to claim 1.
